(19) United States
(12) Patent Application Publication
(10) Pub. No.: US 2016/0074940 A1
(43) Pub. Date: Mar. 17, 2016

(54) METHOD OF CLEANING A PART

(71) Applicant: Pratt & Whitney Canada Corp., Longueuil (CA)

(72) Inventors: Marjolaine COTE, Longueuil (CA); Orlando SCALZO, Montreal (CA); Jonathan RIVARD, Montreal (CA)

(21) Appl. No.: 14/851,212

(22) Filed: Sep. 11, 2015

Related U.S. Application Data
(60) Provisional application No. 62/048,962, filed on Sep. 11, 2014.

(51) Int. Cl. B22F 3/24; B28B 11/22; B29C 67/00

(52) U.S. Cl. CPC B22F 3/24; B29C 67/0096; B28B 11/22; B33Y 40/00

(57) ABSTRACT

A method of removing powder material from a cavity of a part, including supporting the part such than an opening defined in an outer surface of the part and communicating with the cavity is exposed and configured to allow the powder material contained within the cavity to exit therethrough; fluidizing the powder material contained in the cavity; and flowing at least a portion of the fluidized powder material contained in the cavity out of the cavity and out of the part through the opening. The part may be made from additive manufacturing. The powder material may be fluidized through vibration of the part.

### CROSS-REFERENCE TO RELATED APPLICATIONS

This application claims priority from U.S. provisional application No. 62/048,962 filed on Sep. 11, 2014, the entire contents of which are incorporated by reference herein.

### TECHNICAL FIELD

The application relates generally to the cleaning of parts manufactured from powder material and, more particularly, to the cleaning of parts obtained by additive manufacturing.

### BACKGROUND OF THE ART

When a part is created by additive manufacturing from a powder material, powder material is usually contained within cavities and passages of the part at the end of the additive manufacturing process. The fine powder may remain trapped in the cavities and passages, making the part unsuitable for direct application.

### SUMMARY

In one aspect, there is provided a method of removing powder material from a cavity of a part made by additive manufacturing, the method comprising: supporting the part such than an opening defined in an outer surface of the part and communicating with the cavity is exposed and configured to allow the powder material contained within the cavity to exit therethrough; fluidizing the powder material contained in the cavity; and flowing at least a portion of the fluidized powder material contained in the cavity out of the cavity and out of the part through the opening.

In another aspect, there is provided a method of removing powder material from a cavity of a part, the method comprising: engaging the part to a vibrating member while positioning the part such that an opening in an outer surface of the part communicating with the cavity is exposed and configured to allow the powder material contained within the cavity to exit therethrough; and vibrating the part with the vibrating member at an amplitude and frequency combination causing a fluidization of the powder material until at least a portion of the powder material contained within the cavity flows out of the cavity through the opening.

### DESCRIPTION OF THE DRAWINGS

Reference is now made to the accompanying figures in which:

FIG. 1 is a schematic cross-sectional view of a part with a cavity filled with powder material in position for fluidization, in accordance with a particular embodiment;

FIG. 2 is a schematic cross-sectional view of a part with a cavity filled with powder material in position for fluidization, in accordance with another particular embodiment;

FIG. 3 is a schematic, partially broken top tridimensional view of a part in accordance with a particular embodiment, used in Test 1;

FIG. 4 is a schematic, partial bottom tridimensional view of the part of FIG. 3 (also corresponding to a schematic, partial bottom tridimensional view of the part of FIG. 10);

FIG. 5 is a schematic, partial cross-sectional view of the part of FIG. 3 (also corresponding to a schematic partial cross-sectional view of the part of FIG. 8);

FIG. 6 is a schematic, partially broken top tridimensional view of a part in accordance with another particular embodiment, used in Test 2;

FIG. 7 is a schematic, partial bottom tridimensional view of the part of FIG. 6;

FIG. 8 is a schematic, partially broken top tridimensional view of a part in accordance with another particular embodiment, used in Test 3;

FIG. 9 is a schematic, partial bottom tridimensional view of the part of FIG. 8;

FIG. 10 is a schematic, partially broken top tridimensional view of a part in accordance with another particular embodiment, used in Test 4; and

FIG. 11 is a schematic partial cross-sectional view of the part of FIG. 10.

### DETAILED DESCRIPTION

There is described herein a method of removing powder material from a part created by additive manufacturing, i.e. any process where successive layers of material are laid for making a three-dimensional object in which powder material is used. Examples of such additive manufacturing processes include, but are not limited to, selective laser sintering (SLS), selective laser melting (SLM), and electron beam melting (EBM). The powder material is typically deposited, sintered or melted in layers to create the form of the part. The powder material may be a metal powder, a polymer powder, a ceramic powder, etc. It is understood that the method may also be used to remove powder material contained within a cavity of a part due to a process or processes other than additive manufacturing.

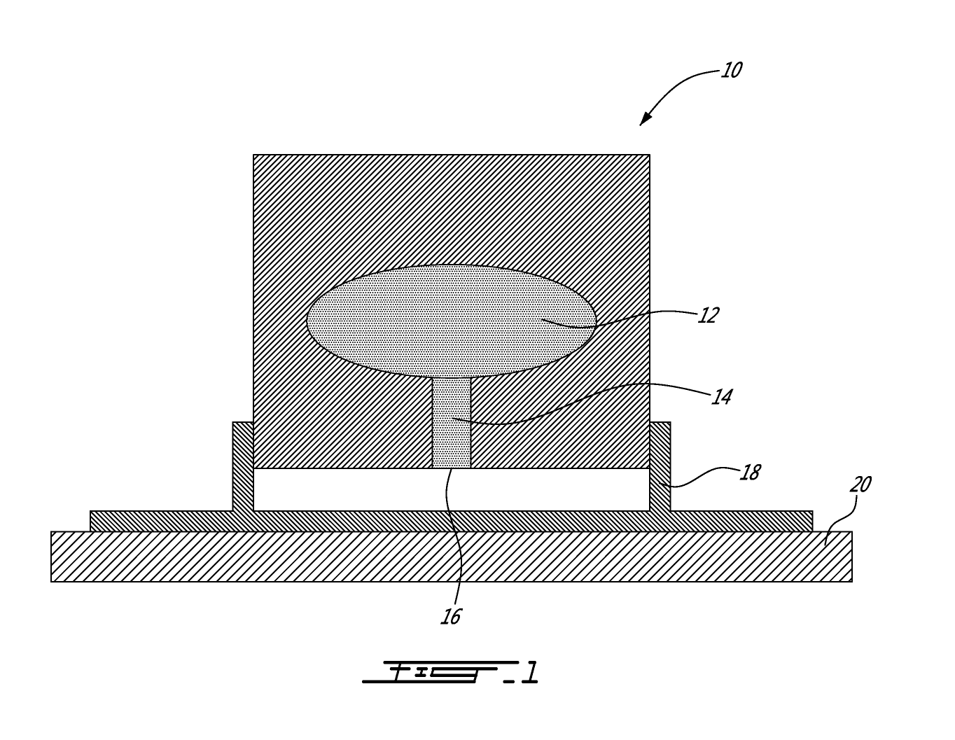

Referring to FIG. 1, a part 10, for example produced by additive manufacturing, is schematically shown. The part 10 includes at least one cavity or passage 12 in which powder material is retained. The retained powder material may be in its initial state (i.e. the state before the additive manufacturing process is performed) and/or may be partially melted and/or partially sintered. Although a single cavity 12 is shown, it understood that several cavities or passages may be present.

The cavity 12 has at least one point of fluid communication with an outer surface of the part 10. In the embodiment shown, the fluid communication is provided by a fluid passage 14 extending between the cavity 12 and an opening 16 defined in the outer surface. Although the cavity 12 is schematically depicted as being completely filled by the powder material, it is understood that a certain amount of the powder material may freely flow out of the opening 16, for example by gravity, and that the cavity 12 may thus be only partially filled with trapped powder material.

The part 10 is placed with the opening 16 located lower than the cavity 12, in any appropriate type of support 18 leaving the opening unobstructed or exposed such that the powder material is free to flow out of the opening 16. In the embodiment shown, the opening 16 faces downward and is spaced above the portion of the support 18 extending under the part 10.

The powder material is then fluidized until it flows out of the cavity 12 through the opening 16. Fluidization as discussed herein refers to any process causing the powder material to pass from a fixed solid like condition to a dynamic solution or fluid like state; in other words, any process causing the powder material to behave and flow like a fluid, while remaining in the solid state. In a particular embodiment, this may be done through suspension of the particulates in a rapidly moving stream of fluid (e.g. gas including but not limited to air, liquid including but not limited to water). For example, a pressurized gas may be injected into the cavity, with sufficient pressure to cause the powder material to behave like a fluid through suspension within the flow of gas. In another embodiment, a microwave mechanism may be used to fluidize the powder. In the embodiments discussed further herein, fluidization is obtained through vibration of the part 10. It is understood that fluidization may alternately be obtained through a combination of methods, for example vibration combined with pressurized gas injection.

In the embodiment shown, fluidization of the powder material is obtained through vibration of the part 10. The part 10 is rigidly engaged to a vibrating member 20 (e.g. vibrating table) through the support 18; the support 18 may be part of the vibrating member 20 or may be a separate element attached thereto through any appropriate type of attachment mechanism. The vibrating member 20 is vibrated at a predetermined frequency and with a predetermined amplitude causing fluidization of the powder material.

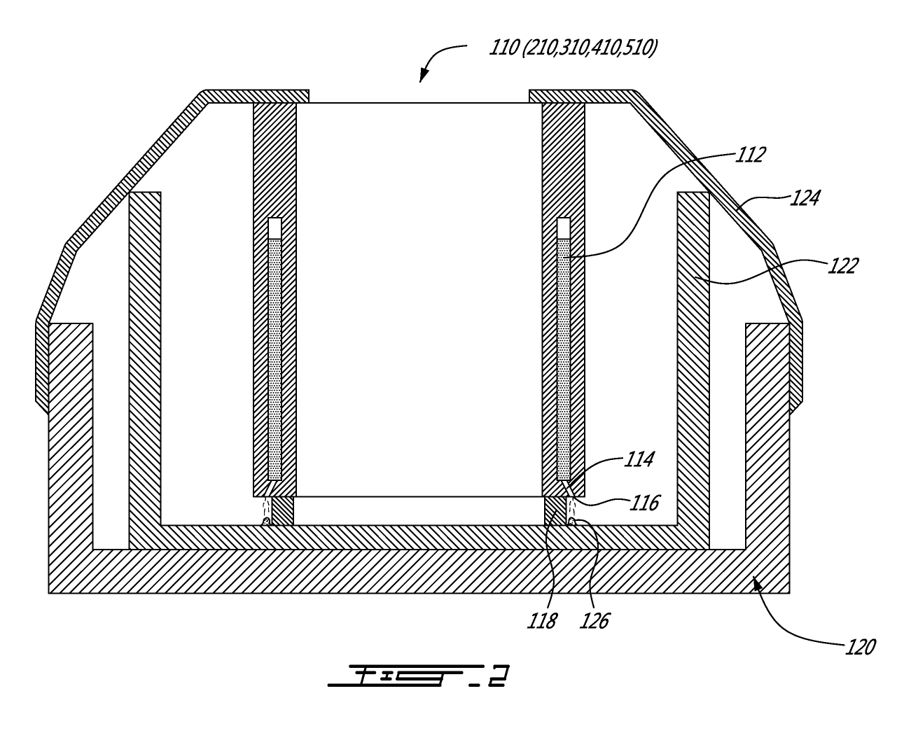

FIG. 2 shows a part 110 produced by additive manufacturing and engaged to a vibrating member 120 (e.g. vibrating table) in accordance with another embodiment. The part 120 is cylindrical and also includes at least one cavity or passage 112 in which powder material is retained. Each cavity 112 communicates with the outer surface of the part 110 through at least one respective a fluid passage 114 extending between the cavity 112 and an opening 116 defined in the outer surface. The part 110 is placed in a container 122 with the opening 116 located lower than the cavity 112, and with spacers 118 positioned between the part 110 and the surface of the container 122 to leave the openings 116 unobstructed or exposed. The container 122 and part 110 are retained to the vibrating member 120 by a plurality of clamps 124. The vibrating member 120 is vibrated at a predetermined combination of frequency and amplitude causing fluidization of the powder material which flows out of each cavity 112 through the passage(s) 114 and opening(s) 116; the powder material is received in the container 122, as shown at 126.

It is understood that other configurations for the engagement of the part 10, 110 to the vibrating member 20, 120 are possible and that the configurations shown herein are provided as examples only.

The combination of frequency and amplitude causing fluidization of the powder material is influenced by the properties of the particulates, including the grain size and distribution, morphology, surface texture, and the nature of the material used. Accordingly, the appropriate combination of frequency and amplitude may be determined through experimentation. In a particular embodiment, before engaging the part 10, 110 on the vibrating member 20, 120, a container containing the same type of powder material as that contained within the part 10, 110 is engaged to the vibrating member 20, 120, and a solid object is placed over the powder material in the container. The container is vibrated by the retaining member 20, 120 at different frequencies and amplitudes, for example by slowly increasing the frequency and lowering the amplitude from a compaction-type vibration, until the solid object sinks into the powder material proportionally to its density in comparison to the density of the fluidized powder material, indicating that the powder material is fluidized. Frequency and/or amplitude can continue to be varied until an unstable behavior of the powder material is observed (explosion-like behaviour of the powder material being forcibly expelled from the container by the vibrations) to determine the range of frequency and amplitude combinations causing fluidization (e.g. as opposed to compaction or unstable behavior). A vibration having the frequency and amplitude combination within the range thus determined to cause fluidization can be applied to the part 10, 110 once engaged on the vibrating member 20, 120 to fluidized the powder material contained therein, until the powder material stops flowing out of the opening(s) 16, 116.

The frequency and amplitude combination of the vibration is selected based on the absorption of the material and to maximize the fluidization capabilities related to the size of each cavity 12, 112, passage 14, 114 and/or opening 16, 116. A plurality of amplitude and frequency combinations can be used.

In a particular embodiment, the fluidization vibrations are performed at a higher frequency than vibrations that would be used to compact the powder material. In a particular embodiment, the fluidization vibrations also have a lower amplitude than vibrations used for compaction. Other configurations are also possible.

In a particular embodiment, the part 10, 110 is set up in two or more different positions and/or orientations in succession with the powder material being fluidized in each position, in order to facilitate removal of the powder. The positions are determined from the configuration of the part 10, 110, of the cavity(ies) 12, 112 and of the fluid passage(s) 14, 114 between the cavity(ies) 12, 112 and the outer surface(s) of the part 10, 110. The fluidization of the powder material can be stopped during the changes in position and/or orientation (e.g. part 10, 110 rigidly engaged to the vibration member 20, 120, disengaged therefrom, and rigidly re-engaged thereto in a different position and/or orientation) or the position and/or orientation of the part 10, 110 can be modified while the powder material is fluidized (e.g. part dynamically engaged to the vibration member 20, 120) such that movement of the part 10, 110 can be combined with the fluidization to facilitate extraction of the powder material.

In addition or alternately, the fluidization process may include disengaging the part 10, 110 from the vibrating member 20, 120 (for example, once the powder material stops flowing from the opening(s) 16, 116), changing the orientation of the part 10, 110 (for example, from a first to a second orientation and back to the first orientation, e.g. turning the part upside-down and back in its original orientation) one or more times and/or impacting the part 10, 110 to help disengage any remaining powder, and re-engaging the part 10, 110 to the vibrating member 20, 120 to again be vibrated at a frequency and amplitude combination causing fluidization of the disengaged powder to allow it to flow out of the opening(s) 16, 116. The part 10, 110 may be further vibrated, turned and/or impacted after the fluidization process to extract remaining powder material, if required.

In a particular embodiment, the mass of the part 10, 110 and of the extracted powder material are measured to verify that at least a predetermined proportion of the powder material is removed during the fluidization process. For example, in a particular embodiment, a major part (e.g. more than 50%) of the powder material that was contained within the cavity/ies 12, 112 is removed by the fluidization process. In a particular embodiment, at least 95% of the powder material that was contained within the cavity/ies 12, 112 is removed by the fluidization process. In a particular embodiment, at least 98% of the powder material that was contained within the cavity/ies 12, 112 is removed by the fluidization process.

In a particular embodiment, the fluidization of the powder material also improves the surface finish of the part 10, 110, for example by removing surface defects such as un-melted particles, oxides, etc.

In a particular embodiment, the fluidization of the powder material permits the cleaning of all cavities, including cavities having different configurations and/or sizes, at the same time. In a particular embodiment, the use of fluidization to remove the powder material from the cavity(ies) 12, 112 limits the amount of manipulation subsequent to the cleaning, allows to save time, and/or allows for cleaning of cavities which are difficult to clean manually.

In a particular embodiment, the fluidization of the powder material allows cleaning of part cavities in a repeatable and automatable fashion, which may help automating mass manufacturing of production parts using additive manufacturing.

In a particular embodiment, the fluidization is performed under a protected environment to recuperate all or a majority of the removed powder material. This may allow for the removed powder material to be re-used in the manufacturing of subsequent parts, in contrast to powder material which may be extracted during a subsequent manufacturing step (e.g. machining) which may be contaminated, for example by cooling or lubricating fluid applied to the part during that manufacturing step.

In a particular embodiment, the part 10, 100 is designed to include as many openings 16, 116 communicating with the cavity/ies 12, 112 as possible and with the openings 16, 116 having a maximum size, without compromising the structural properties of the part 10, 110, such as to facilitate removal of the powder material.

In a particular embodiment, some or all of the cavities 12, 112 are provided with one or more air intake passage(s) providing communication between the cavity 12, 112 and a respective intake opening defined in an outer surface of the part 10, 110, positioned opposite the passage(s) 14, 114 and corresponding opening(s) 16, 116, to facilitate air intake during evacuation of the powder material through the opening(s) 16, 116, such as to reduce the risk of having a vacuum effect preventing the fluidized powder material from exiting the cavities 12, 112. In a particular embodiment, the cavity 12, 112 may be pressurized through injection of pressurized fluid (e.g. air) through the intake passage(s) to help evacuation of the powder material through the opening(s) 16, 116.

It is understood that although the openings 16, 116 have been shown as being positioned lower than the cavities 12, 112 to help gravity drive extraction of the fluidized powder, other configurations are also possible, particularly, but not limited to, where additional forces are used to drive extraction of the fluidized powder. Such additional forces include, but are not limited to, centrifugal force (e.g. through rotation of the part 10, 110 as the powder material is fluidized) and pressure differential (e.g. by injecting pressurized fluid within the cavity 12, 112 and/or by forming a low pressure area adjacent the openings 16, 116).

In a particular embodiment, the part 10, 110 is designed without or with a minimization of the number of sharp corners inside of each cavity 12, 112, such as to reduce the risk of the fluidized powder material remaining stuck within the cavity 12, 112.

Test 1

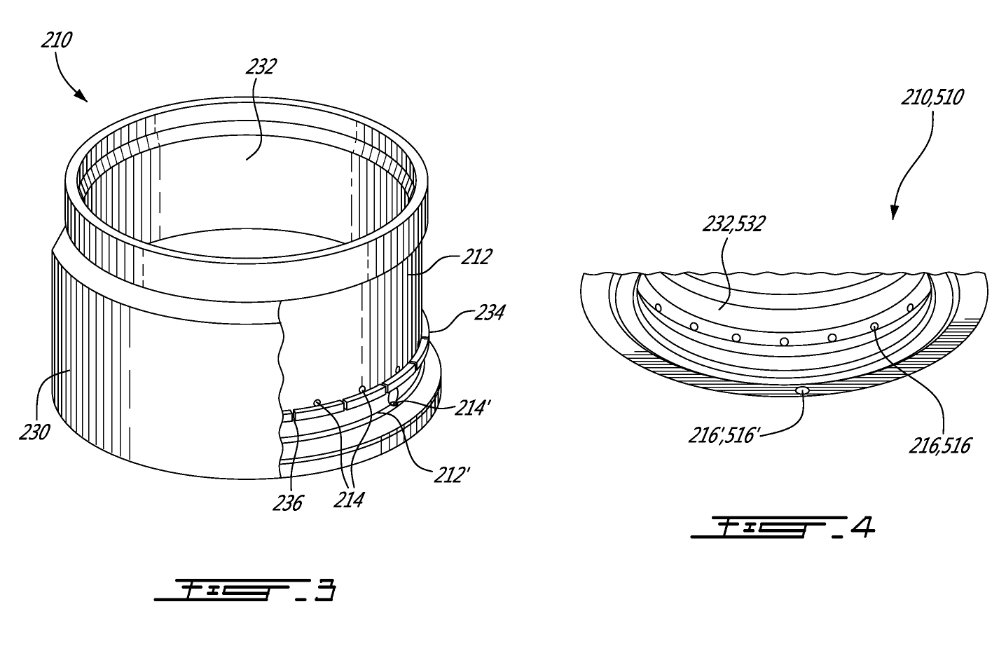

Referring to FIGS. 3-5, a part 210 was manufactured by additive manufacturing and used to test removal of the remaining powder material through fluidization. The part 210 is configured similarly to a bearing runner seal and includes concentric and cylindrical outer and inner walls 230, 232 which are radially spaced apart such as to define two axially spaced annular internal cavities therebetween: a larger upper cavity 212 and a smaller lower cavity 212′ separated by an annular internal wall 234 extending between the outer and inner walls 230, 232. Twenty (20) evacuation passages 214 are circumferentially spaced apart and extend through the inner wall 232 between the bottom of the upper cavity 212′ and the inner surface of the inner wall 232, and each define a respective opening 216 (FIG. 4) in the inner surface. Twenty (20) communication passages 236 are also defined through the annular internal wall 234 to provide communication between the upper and lower cavities 212, 212′; these passages 236 are circumferentially spaced apart and each circumferentially located between two of the evacuation passages 214 of the upper cavity 212. Three (3) evacuation passages 214′ are circumferentially spaced apart, extend between the lower cavity 212′ and the bottom surface of the part 210, and each define a respective opening 216′ (FIG. 4) in the bottom surface. Twenty-three (23) evacuation passages 214, 214′ are thus provided in total between the cavities 212, 212′ and the exterior of the part 210.

The part 210 was manufactured by powder bead laser melting using 316L stainless steel powder CL 20ES with a LaserCusing® M1 machine from Concept Laser. The openings 216, 216′ in the outer surfaces communicating with the passages 214, 214′ were plugged after manufacturing to retain the powder material in the cavities 212, 212′. No heat treatment was done after the fabrication and the part 210 was separated from its build plate using a band saw with a minimum level of coolant to reduce the risks of contamination.

The part 210 was vibrated using an assembly similar to that shown in FIG. 2, where the vibrating member 120 was a vibration table model NTF 350NF distributed by Vibrations Systems & Solutions. The amplitude and frequency of the vibrations of the table 120 were each controlled by a respective pressure regulator.

Before vibrating the part 210, a container with approximately 9 in³ of the powder material was clamped to the vibration table 120 and the amplitude and frequency of vibrations were varied until a solid metal part deposited on the powder material fell to the bottom of the container, indicating that the powder material was fluidized.

The plugs were removed from the openings 216, 216′, and the part 210, spacers 118 and container 122 were weighed before the beginning of the test. The powder material exiting the openings 216, 216′ under the action of gravity during manipulations prior to the application of the vibration was weighed and subtracted from the total mass of the powder material to be able to measure the effect of the fluidization process.

The part 210 was engaged to the vibrating table 120 as per FIG. 2, with the openings 216, 216′ positioned lower than their associated cavity 212, 212′ and exposed to allow powder material to exit therefrom, and the part 210 vibrated with the amplitude and frequency combination found to cause fluidization of the powder material. Once the powder material had stopped flowing out of the openings 216, 216′, the part 210 was unclamped from the vibrating table 120, turned upside-down several times to dislodge powder material potentially trapped in sharp corners of the cavities 212, 212′, re-clamped to the vibrating table 120, and vibrated again using the same amplitude and frequency combination to fluidize the remaining powder material. These steps were repeated until powder material no longer flowed out of the openings 216, 216′.

The weight of extracted powder material was measured, and the volume of extracted powder material was calculated based on a tapped density of 0.166 lb/in³ for 316L/CL 20ES stainless steel powder. The calculated volume was then compared to the theoretical volume of the cavities 212, 212′ in the part 210. Assuming the cavities 212, 212′ were completely full of powder material before the openings 216, 216′ were unplugged, and assuming that the powder material was completely tapped within the cavities 212, 212′, it was found that the fluidization process had removed approximately 95.7% of the volume of powder material within the cavities 212, 212′ of the part 210.

A CT scan was performed on the part 210 and revealed that a small amount of powder remained within the cavities 212, 212′. The amount of remaining powder material examined was consistent with the calculated results, considering that the calculated volume of extracted powder was a minimal volume based on the tapped density of the powder material; there is a possibility that the powder material was not completely tapped within the cavities 212, 212′ before starting extraction.

After the scan, impacts, vibrations with a variety of frequency and amplitude combinations, and upside-down turns were performed on the part 210 to attempt to further remove powder material from the cavities 212, 212′. Additional powder material was removed, and from the weight of the extracted material it was found that the combination of the fluidization process with upside-down turns, impacts and vibration had removed approximately 98.2% of the volume of powder material contained in the cavities 212, 212′.

Test 2

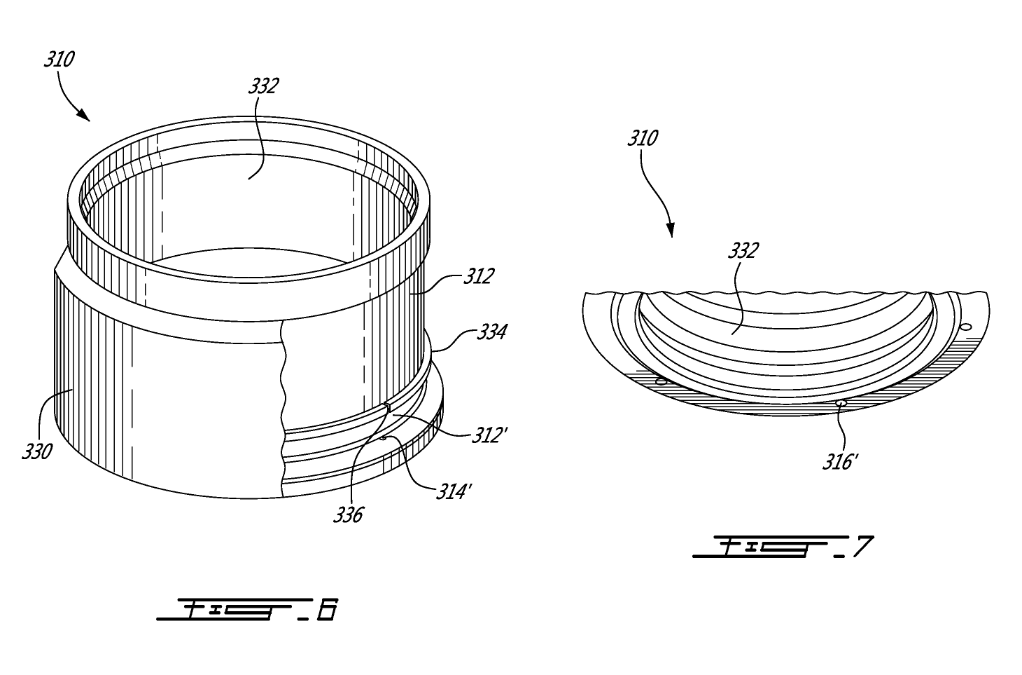

Referring to FIGS. 6-7, another part 310 was manufactured by additive manufacturing using the same process and powder material as that used for the part 210 of Test 1. The part 310 of Test 2 also includes concentric and cylindrical outer and inner walls 330, 332 which are radially spaced apart such as to define a larger upper cavity 312 and a smaller lower cavity 312′, with the cavities 312, 312′ being separated by an annular internal wall 334 extending between the outer and inner walls 330, 332. Six (6) circumferentially spaced apart passages 336 are defined through the annular internal wall 334 to provide communication between the cavities 312, 312′. Six (6) evacuation passages 314′ are circumferentially spaced apart, extend between the lower cavity 312′ and the bottom surface of the part 310, and each define a respective opening 316′ (FIG. 7) in the bottom surface. Accordingly, only six (6) evacuation passages 314′ are provided in total between the cavities 312′, 312 and the exterior of the part 310, and the powder material contained in the upper cavity 312 has to flow to the lower cavity 312′ in order to exit the part 310. Like in Test 1, the openings 316′ were plugged after manufacturing to retain the powder material within the cavities 312, 312′.

The part 310 was also vibrated using an assembly similar to that shown in FIG. 2, using the same vibrating table 120 and the same frequency and amplitude combination as used in Test 1, and using the same test parameters and procedure, including the part 310 being turned upside down between successive periods of fluidization as in Test 1 until the powder material no longer flowed out of the openings 316′.

Like in Test 1, the volume of extracted powder material was calculated from the weight of extracted powder material, theoretical volume of the cavities 312, 312′, and tapped density of the powder material. It was found that the fluidization process had removed approximately 98.3% of the volume of the powder material contained in the cavities 312, 312′ of the part 310.

A CT scan was performed on the part 310 and revealed no visible powder remaining within the cavities 312, 312′. This may be explained by a margin of error on the calculated volume of extracted powder material resulting from the powder material likely not being completely tapped within the cavities 312, 312′ before starting extraction.

Test 3

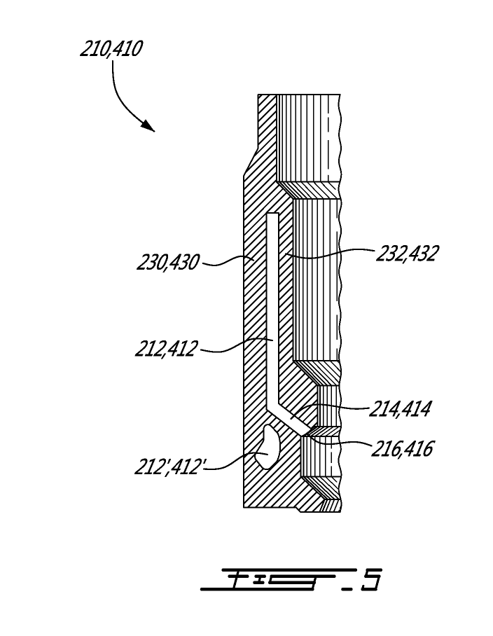

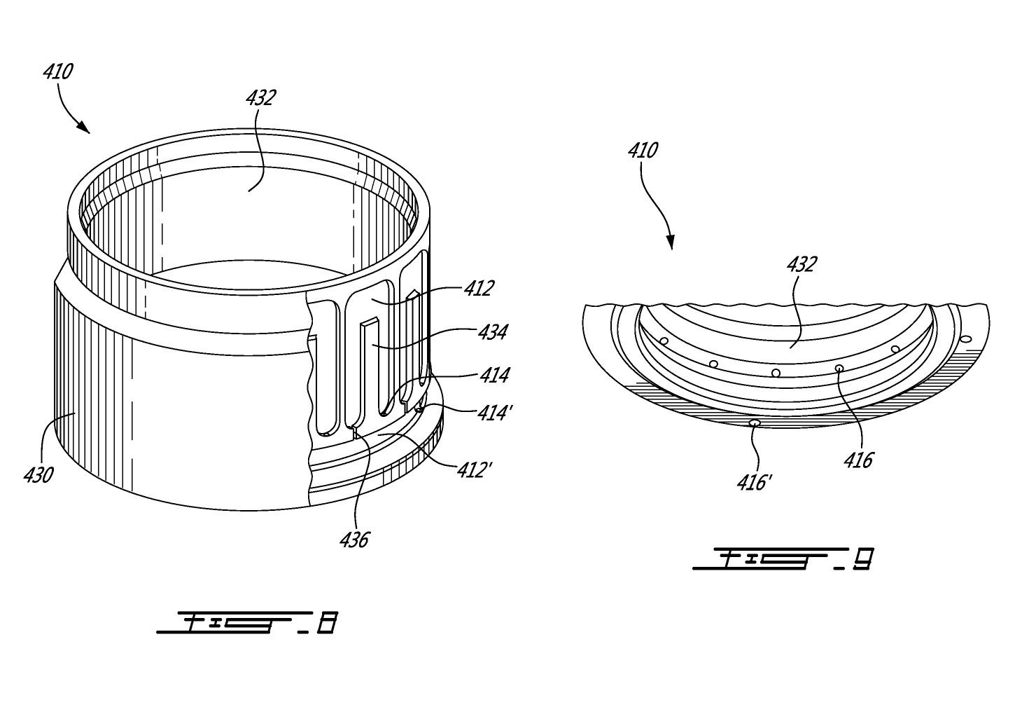

Referring to FIGS. 8-9 and 5, another part 410 was manufactured by additive manufacturing using the same process and powder material as that used for the parts 210, 310 of Tests 1 and 2. This part 410 also includes concentric and cylindrical outer and inner walls 430, 432 which are radially spaced apart. Internal walls 434 extending between the inner and outer walls 430, 432 define fifteen (15) inverted U-shaped upper cavities 412 between the inner and outer walls 430, 432, as well as an annular lower cavity 412′ located under the upper cavities 412. A respective evacuation passage 414 is provided in communication with the bottom of one leg of each of the upper cavities 412, extending through the inner wall 432 between the upper cavity 412 and the inner surface of the inner wall 432 and defining a respective opening 416 (FIG. 9) in the inner surface. A respective passage 436 is defined through the internal walls 434 between the bottom of the other leg of each of the upper cavities 412 and the lower cavity 412′, to provide communication therebetween. Three (3) evacuation passages 414′ are circumferentially spaced apart, extend between the lower cavity 412′ and the bottom surface of the part 410, and each define a respective opening 416′ (FIG. 9) in the bottom surface. In this part, eighteen (18) evacuation passages 414, 414′ are thus provided in total between the cavities 412, 412′ and the exterior of the part 410. Like in Tests 1 and 2, the openings 416, 416′ were plugged after manufacturing to retain the powder material remained within the cavities 412, 412′.

The part 410 was also vibrated using an assembly similar to that shown in FIG. 2, using the same vibrating table 120 and the same frequency and amplitude combination as used in Tests 1-2, and using the same test parameters and procedure, including the part 410 being turned upside down between successive periods of fluidization as in Tests 1-2 until the powder material no longer flowed out of the openings 416, 416′.

Like in Tests 1-2, the volume of extracted powder material was calculated from the weight of extracted powder material, theoretical volume of the cavities 412, 42′, and tapped density of the powder material. It was found that the fluidization process had removed approximately 88.3% of the volume of powder material contained in the cavities 412, 412′ of the part 410.

A CT scan was performed on the part 410 and revealed that three (3) of the upper cavities 412 were still almost completely full of powder material and that some powder material remained in some of the other upper cavities 412. The amount of remaining powder material examined was consistent with the calculated results.

After the scan, impacts, vibrations with a variety of frequency and amplitude combinations, and upside-down turns were performed to attempt to further remove powder material from the part 410. Additional powder material was removed, and from the weight of the extracted material it was found that the combination of the fluidization process with subsequent upside-down turns, impacts and vibration had removed approximately 90.3% of the volume of powder material contained in the cavities 412, 412′.

The part 410 was then cut to examine the state of the remaining powder material, to determine if the remaining powder material was held within the cavities 412, 412′ by partial sintering. The remaining powder material was washed out of the cavities 412, 412′ during cutting, indicating that the remaining powder was at least in majority not sintered.

Possible reasons why some of the powder material was not evacuated by fluidization include a vacuum effect preventing the fluidized material from exiting through the openings 416, 416′ due to air being prevented from entering into the cavities 412, 412′ by the powder material, and/or powder material getting stuck on sharp corners and/or rough surfaces within the cavities 412, 412′.

Test 4

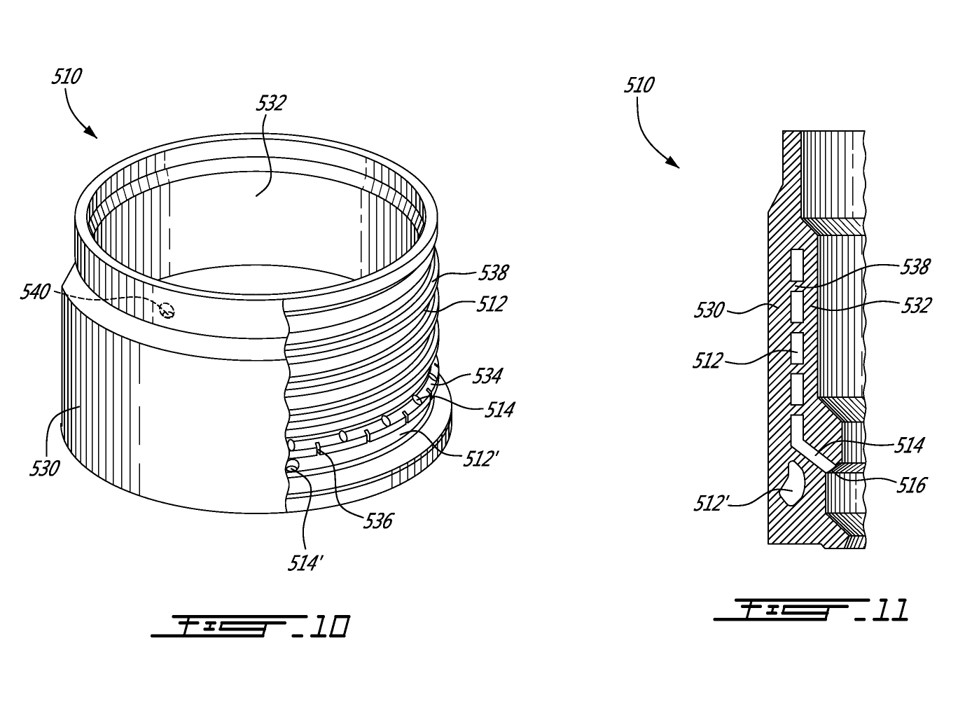

Referring to FIGS. 10-11 and 4, another part 510 was manufactured by additive manufacturing using the same process and powder material as that used for the part of Tests 1 to 3. This part 510 also includes concentric and cylindrical outer and inner walls 530, 532 which are radially spaced apart such as to define two axially spaced annular internal cavities therebetween: a larger upper cavity 512 and a smaller lower cavity 512′ separated by an annular internal wall 534 extending between the outer and inner walls 530, 532. The upper cavity 512 also includes a helical internal wall 538 extending between the outer and inner walls 530, 532, defining a spiral or thread-like configuration for the upper cavity 512. Twenty (20) evacuation passages 514 are circumferentially spaced apart, extend through the inner wall 532 between the lower “thread” of the upper cavity 512 and the inner surface of the inner wall 532, and each define a respective opening 516 (FIG. 4) in the inner surface. Twenty (20) passages 536 are also defined through the annular internal wall 534 to provide communication between the cavities 512, 512′; these passages 534 are circumferentially spaced apart and each circumferentially located between two of the evacuation passages 514 of the upper cavity 512. Three (3) evacuation passages 514′ are circumferentially spaced apart, extend between the lower cavity 512 and the bottom surface of the part 510, and each define a respective opening 516′ (FIG. 4) in the bottom surface. Twenty-three (23) evacuation passages 514, 514′ are thus provided in total between the cavities 512, 512′ and the exterior of the part 510, but the powder material in the upper cavity 512 has to circulate around the part 510 through the spiral path of the upper cavity 512 before reaching the passages 514. Like in Tests 1 to 3, the openings 516, 516′ were plugged after manufacturing to retain the powder material within the cavities 512, 512′.

The part 510 was also vibrated using an assembly similar to that shown in FIG. 2, using the same vibrating table 120 and the same frequency and amplitude combination as used in Tests 1 to 3, and using the same test parameters and procedure, including the part 410 being turned upside down between successive periods of fluidization as in Tests 1 to 3 until the powder material no longer flowed out of the openings 516, 516′.

Like in Tests 1 to 3, the volume of extracted powder material was calculated from the weight of extracted powder material, theoretical volume of the cavities 512, 512′, and tapped density of the powder material. It was found that the fluidization process had removed approximately 58.2% of the volume of powder material contained in the cavities 512, 512′.

A CT scan was performed on the part 510 and revealed that approximately the upper half of the spiral of the upper cavity 512 was full of powder material, which was consistent with the calculated results.

After the scan, impacts, vibrations with a variety of frequency and amplitude combinations, and upside-down turns were performed to attempt to further remove powder material from the part 510. Additional powder material was removed, and from the weight of the extracted material it was found that the combination of the fluidization process with subsequent upside-down turns, impacts and vibration removed approximately 63.7% of the volume of powder material contained in the cavities 512, 512′.

The part 510 was then cut to examine the state of the remaining powder material, to determine if the remaining powder material was held within the cavities 512, 512′ by partial sintering. The remaining powder material was washed out of the cavities 512, 512′ during cutting, indicating that the remaining powder was at least in majority not sintered.

Possible reasons why some of the powder material was not evacuated by fluidization include a vacuum effect preventing the fluidized material from exiting through the openings 516, 516′ due to air being prevented from entering into the cavities 512, 512′ by the powder material, and/or powder material getting stuck on sharp corners and/or rough surfaces within the cavities 512, 512′.

Another part similar to part 510 was also vibrated using with the same vibrating table 120 and the same frequency and amplitude combination, and using the same test parameters and procedure, including the part being turned upside down between successive periods of fluidization until the powder material no longer flowed out of the openings. This part was identical to part 510 except that an intake passage 540 (showed in phantom in FIG. 7) was additionally formed through the outer wall 530 in communication with the upper end of the spiral of the upper cavity 512, to allow air to flow within the cavity 512 during the fluidization process in an attempt to reduce or eliminate the vacuum effect. From this part, it was found that the fluidization process removed approximately 77.1% of the volume of powder material contained in the cavities (as opposed to 58.2% in the part 510 without the intake passage 540). This result showed the significant role of the vacuum effect in preventing the fluidized powder material from exiting the cavities 512, 512′. Possible reasons why some of the powder material still remained within the cavities after fluidization include powder material getting stuck on sharp corners and/or rough surfaces within the cavities, as the threaded configuration of the upper cavity included such corners and surfaces. Possibly combining the fluidization with movement of the part, for example rotating the part on its center axis to help the fluidized material circulate along the threads of the upper cavity, could further improve the results.

The above description is meant to be exemplary only, and one skilled in the art will recognize that changes may be made to the embodiments described without departing from the scope of the invention disclosed. Modifications which fall within the scope of the present invention will be apparent to those skilled in the art, in light of a review of this disclosure, and such modifications are intended to fall within the appended claims.

1. A method of removing powder material from a cavity of a part made by additive manufacturing, the method comprising:
supporting the part such than an opening defined in an outer surface of the part and communicating with the cavity is exposed and configured to allow the powder material contained within the cavity to exit therethrough;
fluidizing the powder material contained in the cavity; and
flowing at least a portion of the fluidized powder material contained in the cavity out of the cavity and out of the part through the opening.

2. The method as defined in claim 1, wherein the part is supported with the opening positioned lower than the cavity.

3. The method as defined in claim 1, wherein flowing at least a portion of the fluidized powder material contained in the cavity out of the cavity and out of the part through the opening includes flowing a major part of the powder material contained in the cavity out of the cavity and out of the part through the opening.

4. The method as defined in claim 1, flowing at least a portion of the fluidized powder material contained in the cavity out of the cavity and out of the part through the opening includes flowing at least 95% of the powder material contained in the cavity out of the cavity and out of the part through the opening.

5. The method as defined in claim 1, wherein fluidizing the powder material contained in the cavity and flowing at least a portion of the fluidized powder material contained in the cavity out of the cavity and out of the part through the opening include at least one instance of stopping the fluidization, changing an orientation of the part, and restarting the fluidization.

6. The method as defined in claim 1, wherein fluidizing the powder material contained in the cavity and flowing at least a portion of the fluidized powder material contained in the cavity out of the cavity and out of the part through the opening include dynamically changing an orientation of the part while the powder material is fluidized.

7. The method as defined in claim 1, wherein supporting the part includes engaging the part with a vibrating member and fluidizing the powder material includes vibrating the part with the vibrating member.

8. The method as defined in claim 7, further including, before supporting the part, determining a combination of frequency and amplitude of vibrations causing fluidization of the powder material, and wherein vibrating the part is performed at the determined combination of frequency and amplitude.

9. The method as defined in claim 1, further comprising flowing air into the cavity through an intake opening as the fluidized powder material flows out of the cavity.

10. The method as defined in claim 1, wherein flowing the fluidized powder material out of the cavity and out of the part through the opening includes flowing the fluidized powder material from the cavity to another cavity and flowing the fluidized powder material from the cavity out of the part through the opening.

11. The method as defined in claim 1, wherein the powder material is metal powder remaining within the cavity after manufacturing the part using selective laser melting.

12. A method of removing powder material from a cavity of a part, the method comprising:
engaging the part to a vibrating member while positioning the part such that an opening in an outer surface of the part communicating with the cavity is exposed and configured to allow the powder material contained within the cavity to exit therethrough; and
vibrating the part with the vibrating member at an amplitude and frequency combination causing a fluidization of the powder material until at least a portion of the powder material contained within the cavity flows out of the cavity through the opening.

13. The method as defined in claim 12, wherein the part is engaged with the opening positioned lower than the cavity.

14. The method as defined in claim 12, wherein the part is vibrated and the powder material is fluidized until a major part of the powder material contained within the cavity flows out of the cavity through the opening.

15. The method as defined in claim 12, wherein the part is vibrated and the powder material is fluidized until at least 95% of the powder material contained within the cavity flows out of the cavity through the opening.

16. The method as defined in claim 12, wherein vibrating the part and fluidizing of the powder material include at least one instance of stopping the vibration and fluidization, changing an orientation of the part, and restarting the vibration and fluidization.

17. The method as defined in claim 12, wherein vibrating the part and fluidizing of the powder material include changing an orientation of the part as the powder material is fluidized.

18. The method as defined in claim 12, further including, before engaging the part to the vibrating member, determining the amplitude and frequency combination causing fluidization of the powder material by varying the amplitude and frequency of vibrations applied to a sample of the powder material until a solid object received on top of the sample sinks within the powder material.

19. The method as defined in claim 12, further comprising flowing air into the cavity through an intake opening as the powder material flows out of the cavity.

20. The method as defined in claim 12, including flowing the powder material contained within the cavity from the cavity to another cavity and flowing the powder material from the cavity out of the part through the opening.
